(19) United States
(12) Patent Application Publication
(10) Pub. No.: US 2012/0072437 A1
(43) Pub. Date: Mar. 22, 2012

(54) Real-Time Constituent Targeting System

(76) Inventor: Joshua Thomas Ouellette, Navarre, FL (US)

(21) Appl. No.: 13/158,435

(22) Filed: Jun. 12, 2011

Related U.S. Application Data
(60) Provisional application No. 61/355,139, filed on Jun. 15, 2010.

(51) Int. Cl. G06F 17/30

(52) U.S. Cl. 707/758; 707/E17.014

(57) ABSTRACT

Real-time constituent targeting systems that provide users with a constantly updated queue of contact information for constituents who are likely positively disposed towards a campaigns candidate or cause. Real-time constituent targeting systems may rely on a variety of available constituent information, whether individualized or averaged, and the historical disposition results of previously attempted contacts by the campaign.

### PRIORITY

This application claims priority to U.S. Provision Application No. 61/355,139 filed Jun. 15, 2010.

### FIELD

This application relates generally to constituent targeting. In particular, this application relates to real-time targeting systems that identify constituents who are likely to have a positive disposition towards a particular candidate or cause.

### BACKGROUND

Non-profit organizations and political election committees conduct thousands of campaigns every year in which they attempt to identify supportive constituents or voters. In the process, many campaigns attempt to maximize the effectiveness of their limited resources by making sure they only attempt to contact “targeted” constituents: those that due to the application of some metrics have been identified as more likely than others to be receptive to the campaign's message, or have an otherwise positive disposition towards the campaign's candidate or cause. Traditionally, this targeting is accomplished through the generation of lists of targeted constituents.

These lists can be developed through methods as simple as identifying constituents who've voted in prior elections, or can be generated using complex econometric models that take into account geographic location, household income, and other consumer data. Often, expert consultants are paid to help refine and improve these lists. These lists are then printed out and handed to staff or volunteers who attempt contact. These lists may also be loaded into software programs that users can then log-on to in order to attempt to contact with the targeted constituents.

### SUMMARY

Embodiments of real-time constituent targeting systems according to the present invention can include real-time targeting software operating on one or more computers connected to the Internet or local network and configured to exchange information with various user interface devices (such as a computer, telephone, smart-phone, or PDA). The real-time targeting software can operate in conjunction with one or more databases storing constituent information located on the local network or connected to via the Internet. A virtual queue, stored within the real-time targeting software or on a database, provides contact information for constituents who should be the next constituents contacted by users. A user of the system who is attempting to contact constituents is given the contact information for a constituent from the queue, and that constituent is then removed from the queue. The user then attempts contact with the constituent. Once a user finishes attempting contact with a constituent, the user inputs the identified disposition of the constituent into the system. If the attempted contact resulted in identifying a constituent with a positive disposition towards the campaign's candidate or cause, the software searches the relevant databases to find similar constituents based on a predefined algorithm and search parameters. If this search successfully identifies more targeted constituents, these constituents are added to the queue from which future users will be fed constituent contact information in order to attempt contact.

In some embodiments, the virtual queue may be initially populated with constituent contact information at random. In other embodiments the queue may be initially populated according to pre-defined parameters, which might include the use of any available constituent information.

Similarly, some embodiments may include methods for adding constituent contact information to the virtual queue when the total number of constituents in the queue drops below a certain threshold. These methods may include adding constituent contact information to the queue at random, or using some pre-defined parameters and any available constituent information.

In some embodiments of the real-time constituent targeting system, users may be interacting with the system via a variety of user interface devices. Users may be attempting contact with individuals via the phone and entering the disposition results via the phone. Users may also be attempting contact in person, and entering the results of those contacts by phone, smart-phone, or PDA (Personal Digital Assistant). In yet other embodiments, users may be entering in the results of attempted contacts via a computer or through a webpage.

### BRIEF DESCRIPTION OF THE DRAWINGS

The following description can be better understood in light of Figures, in which:

FIG. 1 is a schematic drawing of a hardware system for an exemplary real-time constituent targeting system;

FIG. 2 is a flow-chart of an exemplary method of an exemplary real-time constituent targeting system;

Together with the following description, the Figures demonstrate and explain the principles of real-time constituent targeting systems and methods for using and employing real-time constituent targeting systems. In the Figures, the size, number and configuration of components may be exaggerated for clarity.

### DETAILED DESCRIPTION

The following description supplies specific details in order to provide a thorough understanding. Nevertheless, the skilled artisan would understand that embodiments of real-time targeting systems and associated methods of using the system can be implemented and used without employing these specific details. Indeed, exemplary embodiments and associated methods can be placed into practice by modifying the illustrated units and associated methods and can be used in conjunction with any other devices and techniques conventionally used in the industry.

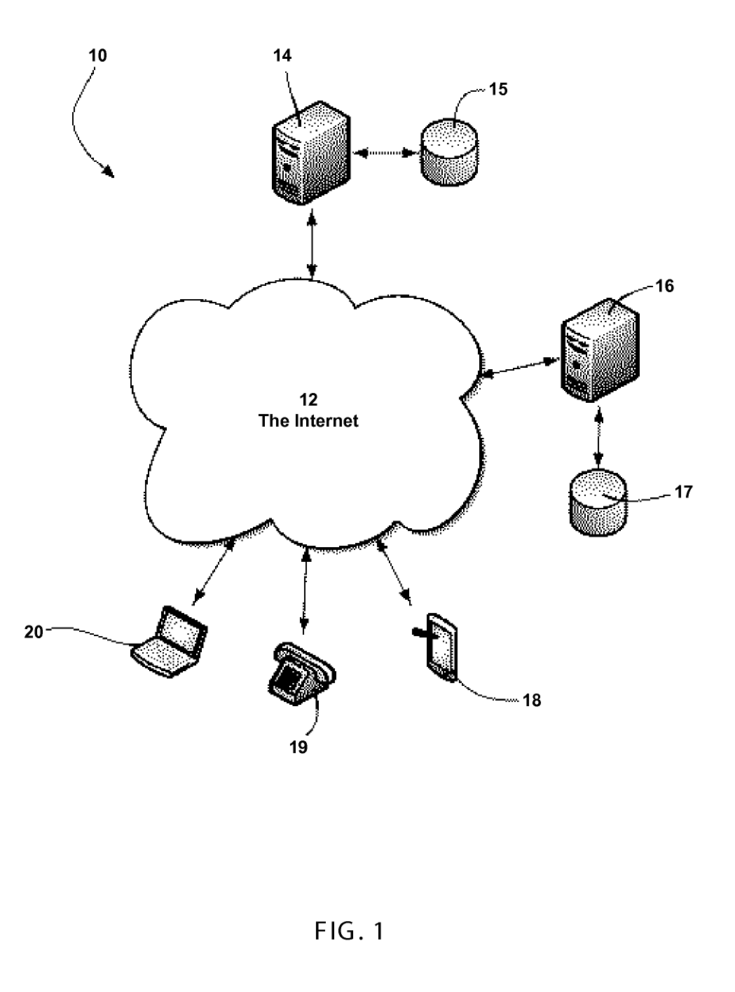

One exemplary system 10 for accommodating a real-time targeting system is illustrated in FIG. 1. System 10 can include servers 14 and 16 and databases 15 and 17 connected through the Internet 12 to user interface devices such as a computer 20 a phone 19 or a smart-phone or personal digital assistant 18. The real-time targeting software may be served from server 14 and the virtual queue may be stored on database 15. Constituent information may be served from server 16 and stored in database 17. A real-time constituent targeting system can be made of one or more different software modules, each module working with the other modules to provide embodiments of real-time constituent targeting systems.

In some embodiments, the real-time targeting software and constituent information can be served entirely from server 14 and stored in database 15 along with the virtual queue, obviating the need for server 16 and database 17. In other embodiments, the real-time targeting software and constituent information may be stored and served on a multitude of servers and databases. For example, another embodiment may have the real-time-targeting software served on server 14, but the virtual queue may be stored with constituent information on database 17 connected through server 16. Embodiments of real-time constituent targeting systems according to the present invention can physically reside and operate in any configuration of servers and software modules sufficient to provide the features and services as described below and illustrated.

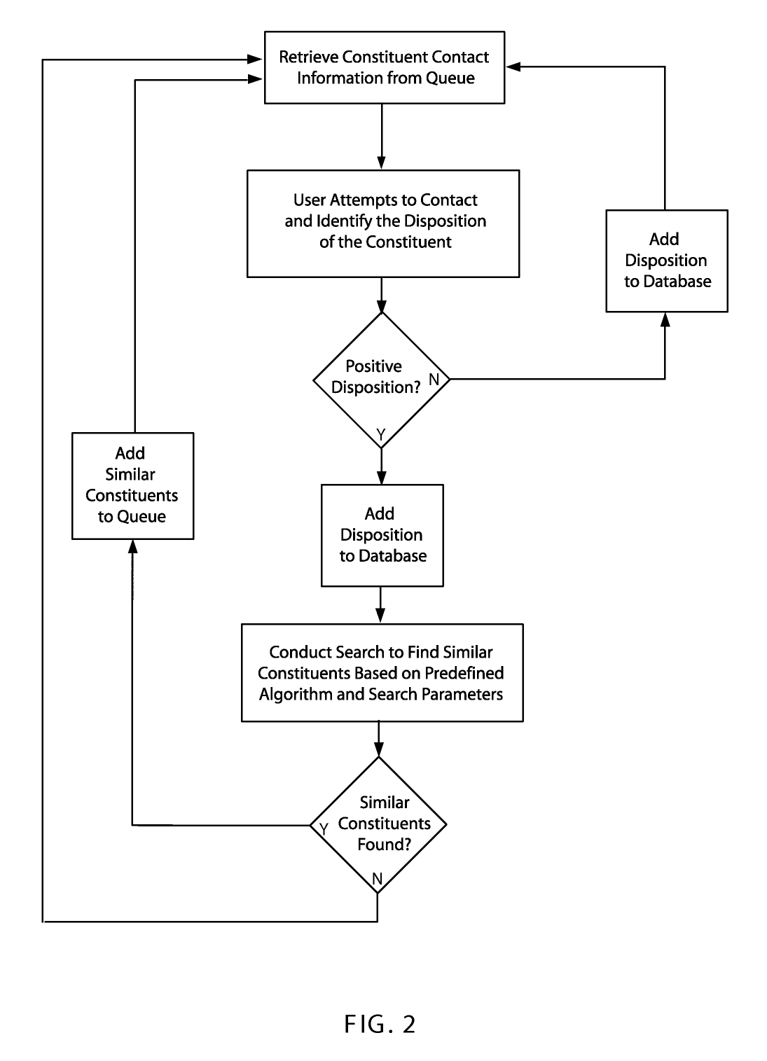

As shown in FIG. 2 embodiments of an exemplary real-time constituent targeting system can provide users with a constantly updated queue of contact information for constituents identified by the system as likely to be positively disposed towards a particular campaign's candidate or cause. A user is given the contact information for a particular constituent from the virtual queue and then attempts to make contact with that constituent. That constituent's contact information is then removed from the queue. Upon completion of the attempted contact, the user inputs the results of the contact (for example, whether the constituent is positively disposed or negatively disposed, and to what degree). The real-time targeting software then analyzes the inputted result. If the disposition was negative (including if the contact was unsuccessful), the software refers the user to the next constituent's contact information in the queue to attempt contact. If the disposition is positive, the software conducts a search of the constituent database in order to find similarly disposed constituents based on a predefined algorithm and search parameters. If similarly disposed constituents are identified, the software adds the contact information for those constituents to the queue, and then refers the user to the next constituent to be contacted from the queue. If no similar constituents are identified, the software refers the user to the next constituent's contact information in the queue.

In various embodiments, the predefined algorithm and search parameters used by the real-time targeting software can take on a variety of forms. The software may rely on simply geographic information in conducting it's search, or could rely on more complicated econometric models that take into consideration household income levels and consumer spending habits for a particular constituent. The software may rely on both individualized data for a particular constituent, or averaged data across a particular geographic region. A multitude of possibilities may be used depending on the data available to a particular campaign and the size of the geographic region targeted. The search algorithm may also take into consideration the historical results of previous contacts as identified and processed by the real-time targeting system in the past.

In addition to any previously indicated modification, numerous other variations and alternative arrangements can be devised by those skilled in the art without departing from the spirit and scope of this description. Thus, while the information has been described above with particularity and detail in connection with what is presently deemed to be the most practical and preferred aspects, it will be apparent to those of ordinary skill in the art that numerous modifications, including, but not limited to, form, function, manner of operation and use can be made without departing from the principles and concepts set forth herein. Also, as used herein, examples are meant to be illustrative only and should not be construed to be limiting in any manner.

What is claimed:

1. A method for providing real-time constituent targeting comprising:
(a) receiving information about a constituent;
(b) determining, as soon as the information is received, one or more constituents to contact based at least in part on the received information;
(c) placing an identifier for a constituent identified in step (b) in a queue for future contact.

2. The method of claim 1, wherein the information about a constituent comprises any one of contact information, location, disposition on a particular issue, disposition on a particular candidate, opinion, preference, or economic data.

3. The method of claim 1 wherein step (c) comprises placing identifiers for a plurality of constituents in the queue.

4. The method of claim 1 wherein step (b) further comprises conducting a search.

5. The method of claim 1 wherein step (b) further comprises determining that other constituents are similar in at least one regard to the constituent about whom information is received.

6. The method of claim 1 wherein step (b) further comprises determining that other constituents are not similar in at least one regard to the constituent about whom information is received.

7. The method of claim 1 wherein step (b) involves the application of a predefined set of rules or algorithm.

8. The method of claim 1 further comprising the step of adding the received information to a database.

9. The method of claim 1 wherein the received information is received from a telephonic interface.

10. The method of claim 1 wherein the received information is received over the internet.

11. The method of claim 1 wherein the received information is received from a portable electronic device.

12. The method of claim 1 further comprising the step of serving constituent contact information to a volunteer.

13. The method of claim 12 wherein said serving is accomplished via a web-based interface.

14. The method of claim 12 wherein said serving is accomplished via a telephonic interface.

15. The method of claim 12 wherein said serving is accomplished via an interface on a portable electronic device.

16. The method of claim 1 further comprising adding identifiers for constituents to the queue at random.

17. A system for providing real-time constituent targeting comprising:
a database server capable of storing constituent information;
a server capable of determining, as soon as information about a constituent is received, one or more constituents to contact based at least in part on the received information;
computer memory for storing a queue of identifiers of constituents to be contacted in the future.

18. The method of claim 17 further comprising a user terminal for receiving constituent information.

19. The method of claim 18 wherein said terminal is one of a telephone, computer, or portable electronic device.

20. A non-transitory computer usable medium having a computer readable program code embodied therein, said computer readable program code adapted to performing a method comprising:
(a) receiving information about a constituent;
(b) determining, as soon as the information is received, one or more constituents to contact based at least in part on the received information;
(c) placing an identifier for a constituent identified in step (b) in a queue for future contact.
